(19) United States
(12) Patent Application Publication
(10) Pub. No.: US 2012/0248874 A1
(43) Pub. Date: Oct. 4, 2012

(54) METHOD AND APPARATUS FOR IMPROVING THE OPERATION OF AN AUXILIARY POWER SYSTEM OF A THERMAL POWER PLANT

(75) Inventors: Jiuping Pan, Raleigh, NC (US); Cathy-Yao Chen, Beijing (CN); Zhenyuan Wang, Cary, NC (US); Lars Gertman, Vasteras (SE)

(73) Assignee: ABB RESEARCH LTD., Zurish (CH)

(21) Appl. No.: 13/502,856

(22) PCT Filed: Oct. 22, 2010
(86) PCT No.: PCT/US10/53822

§ 371 Date: Jun. 20, 2012

Related U.S. Application Data
(60) Provisional application No. 61/254,708, filed on Oct. 25, 2009.

(51) Int. Cl. H02J 9/00

(52) U.S. Cl. 307/64

(57) ABSTRACT

Apparatus and method for controlling power in an auxiliary power system of a thermal power plant having a generator and one or more auxiliary buses. The apparatus includes adjustable speed drives and capacitance sources for connection to the one or more auxiliary buses and sensors for measuring voltage and reactive power on the one or more auxiliary buses. A controller is operable to control the adjustable speed drives and the capacitance sources to control the power factor of the auxiliary power system, while providing steady state voltage regulation and dynamic voltage support.

### BACKGROUND OF THE INVENTION

The present invention relates to thermal power plants and more particularly to auxiliary power systems for such plants.

The portion of power flow that results in a net transfer of energy in one direction (over a complete AC waveform cycle) is known as real power (or useful or active power). That portion of power flow that is due to stored energy in the load returning to the source in each cycle is known as reactive power. Apparent power is the vector sum of real and reactive power.

The power factor of an AC power system is defined as the ratio of real power to apparent power, and is a number between 0 and 1. Where the waveforms are purely sinusoidal, the power factor is the cosine of the phase angle (φ) between the current and voltage sinusoid waveforms. Power factor equals 1 when the voltage and current are in phase, and is zero when the current leads or lags the voltage by 90 degrees. If the load is purely reactive, then the voltage and current are 90 degrees out of phase and there is no net energy flow. Power factors are usually identified as “leading” or “lagging” to show the sign of the phase angle, where leading indicates a negative sign.

For two AC power systems transmitting the same amount of real power, the system with the lower power factor will have higher circulating currents due to energy that returns to the source from energy storage in the load. These higher currents in a power system will produce higher losses and reduce overall transmission efficiency. A lower power factor circuit will have a higher apparent power and higher losses for the same amount of real power transfer. Thus, it is desirable to maintain a high power factor in an AC power system.

A thermal power plant has an auxiliary power system for providing power to auxiliary processes, i.e., motor-driven loads, electrical power conversion and distribution equipment and instruments and controls. The power factor of an auxiliary power system of a thermal power plant is important because the auxiliary processes of a thermal power plant typically consume about 5˜8% of the electrical power produced by the power plant. For a coal-fired power plant having SO₂ scrubbers, total power consumption by auxiliary processes may be as high as 10% of the gross generation capacity of the plant. Most of the power consumed by auxiliary processes (up to 80%) is by large electric motors that are typically connected to medium voltage switchyards, which are supplied with power through one or more auxiliary transformers. Electric motors running at or near full nameplate loading have much greater power factors than electric motors running unloaded or lightly loaded. For this and other reasons, it is desirable to operate a base load power plant at its rated, continuous capacity. However, many base load power plants now often operate at only 50-70% of their rated capacities due to the increased presence of renewable energy sources (e.g. wind mill farms), increased system operating reserve requirements and competitive energy markets. As such, pumps and fans driven by electric motors typically run at only partial load during most operational periods. Even when a power plant is running at full capacity, pumps and fans typically do not run at their rated capacity because of required design margins. Thus, the power factor of an in-plant electrical power system of a thermal power plant is typically around only 0.8˜0.85.

The present invention is directed to a method and apparatus for improving the overall operation of a thermal power plant by, inter alia, improving the power factor of its auxiliary power system.

### SUMMARY OF THE INVENTION

In accordance with the present invention, computer readable medium is provided having computer-readable instructions stored thereon for execution by a processor to perform a method of controlling power in an auxiliary power system of a thermal power plant having a generator and one or more auxiliary buses. Each auxiliary bus has one or more adjustable speed drives connected thereto and one or more capacitance sources connected thereto. Each adjustable speed drive has an active rectifier unit. In accordance with the method, a voltage of each auxiliary bus is monitored. The power factor of the auxiliary power system is controlled to have a predetermined power factor value. The control of the power factor includes controlling the reactive power of each adjustable speed drive and each capacitance source. When an auxiliary bus is affected by a voltage disturbance such that its voltage is outside a predetermined range, the control of the power factor of the auxiliary power system is stopped and the voltage on the affected auxiliary bus is controlled to move the voltage back into the predetermined range. The control of the voltage includes increasing the reactive power of the one or more adjustable speed drives connected to the affected auxiliary bus when the voltage of the affected auxiliary bus is below the predetermined range, and decreasing the reactive power of the one or more adjustable speed drives connected to the affected auxiliary bus when the voltage of the affected auxiliary bus is above the predetermined range.

Also provided in accordance with the present invention is apparatus for controlling power in an auxiliary power system of a thermal power plant having a generator and one or more auxiliary buses. The apparatus includes one or more adjustable speed drives for connection to the one or more auxiliary buses, one or more capacitance sources for connection to the one or more auxiliary buses and sensors for measuring voltage and reactive power on the one or more auxiliary buses. Each adjustable speed drive has an active rectifier unit. The apparatus also includes a controller operable to perform the method described above of controlling power in the auxiliary power system.

### BRIEF DESCRIPTION OF THE DRAWINGS

The features, aspects, and advantages of the present invention will become better understood with regard to the following description, appended claims, and accompanying drawings where:

FIG. 1 is a schematic drawing of a power generation plant in which the method and apparatus of the present invention may be utilized;

FIG. 2 is a circuit schematic of an adjustable speed drive that may be used in the method and apparatus of the present invention;

FIGS. 3a-c are phasor diagrams showing the control of reactive power in an auxiliary bus of the power generation plant;

FIG. 4 is a schematic diagram of an auxiliary power control program that controls the power factor of an auxiliary power system of the power generation plant, while providing steady state voltage regulation and dynamic voltage support;

FIGS. 5a and 5b show a flow chart of a power factor controller of the auxiliary power control program; and

FIG. 6 shows a flow chart of a dynamic voltage controller of the auxiliary power control program.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

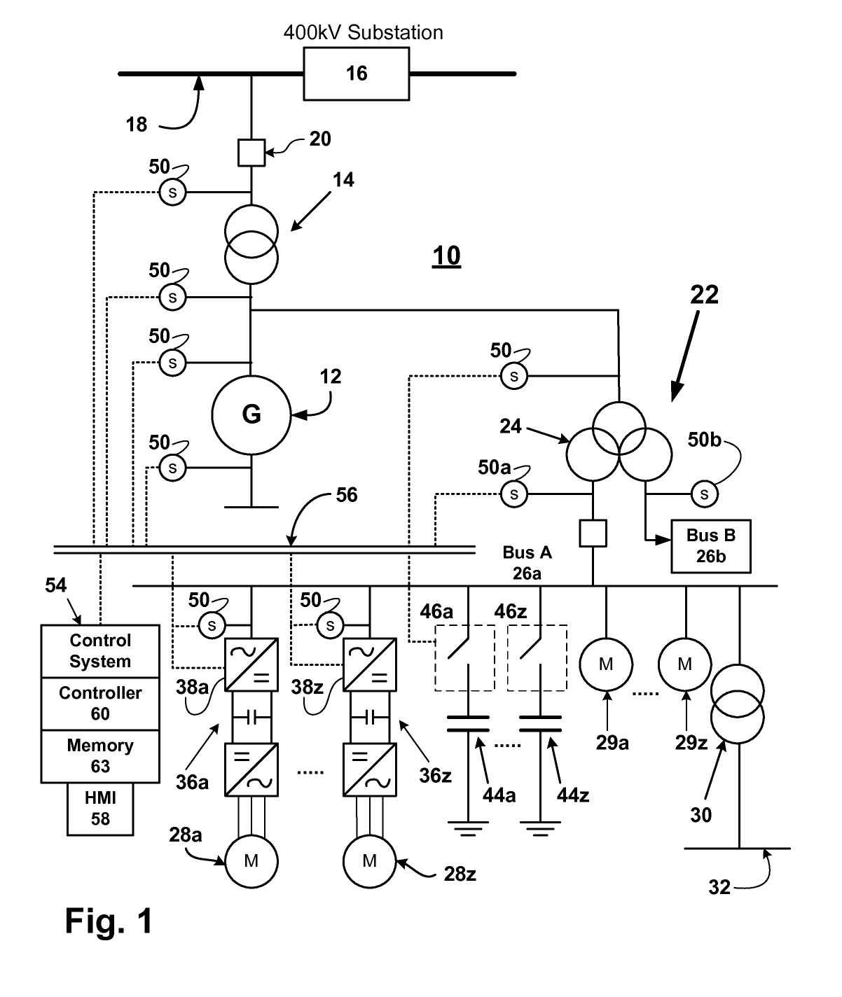

Referring now to FIG. 1 there is shown a schematic drawing of a power generation plant 10 in which the method and apparatus of the present invention may be utilized. The generation plant 10 may be a thermal power plant, such as a coal-fired power plant, a nuclear power plant, a solar power plant, or a geothermal power plant. The generation plant 10 includes a generator 12 that generates electricity from mechanical energy supplied by one or more steam-driven turbines (not shown). A step-up main transformer 14 converts the electrical power from the generator 12 to a voltage which is suitable for transmission, e.g. greater than 110 kV. Electrical power from the main transformer 14 is supplied to one or more substations 16 over a transmission network 18. The main transformer 14 is connected to the transmission network 18 through a main circuit breaker 20. Each substation 16 steps down the voltage and provides the generated power to end user customers through a distribution network.

The generation plant 10 has an auxiliary power system 22 that includes one or more step-down auxiliary transformers 24 and one or more auxiliary buses 26. Each auxiliary transformer 24 is connected to the output of the generator 12 and converts electrical power from the generator 12 to a voltage, which is suitable for auxiliary loads in the generation plant 10, such as 2,400 V, 4,160 V or 6,900 V. This voltage is supplied to auxiliary loads by the one or more main auxiliary buses 26. In the embodiment shown in FIG. 1, there is a main auxiliary bus 26a and a main auxiliary bus 26b. The main auxiliary bus 26b has the same construction and operating capacity and the same auxiliary loads connected thereto as the main auxiliary bus 26a and, thus, for purpose of brevity will not be described. On main auxiliary bus 26a, the auxiliary loads include electric motors 28a-z, 29a-z which may have a rating of 1-5 MW. The motors 28a-z, 29a-z drive auxiliary devices, such as fans, compressors and pumps that are necessary for operation of the plant 10. These auxiliary devices perform tasks such as pumping feedwater to boiler(s) and providing combustion air and fuel to burners. The voltage on the main auxiliary bus 26a may be further stepped down to a lower voltage (such as 480 V) by a lower voltage auxiliary transformer 30. This lower voltage may be supplied over a low voltage bus 32 to lower voltage devices and systems, such as small motors and lighting systems.

In accordance with the present invention, at least a portion of the electric motors 28a-z, 29a-z is connected to the main auxiliary bus 26a by adjustable speed drives (ASDs) 36a-z having an active rectifier unit (ARU). In the embodiment shown in FIG. 1, some of the motors 28a-z, 29a-z are not connected to the auxiliary bus 26a through ASDs and are run at constant speed. More specifically, motors 28a-z are connected to ASDs 36a-z, while motors 29a-z are not connected to ASDs and are run at constant speed. The motors 28a-z may have been retrofitted with the ASDs 36a-z, having originally been run as constant speed motors or having been provided with power through conventional variable frequency drives having fixed rectifiers, i.e., utilizing only diodes.

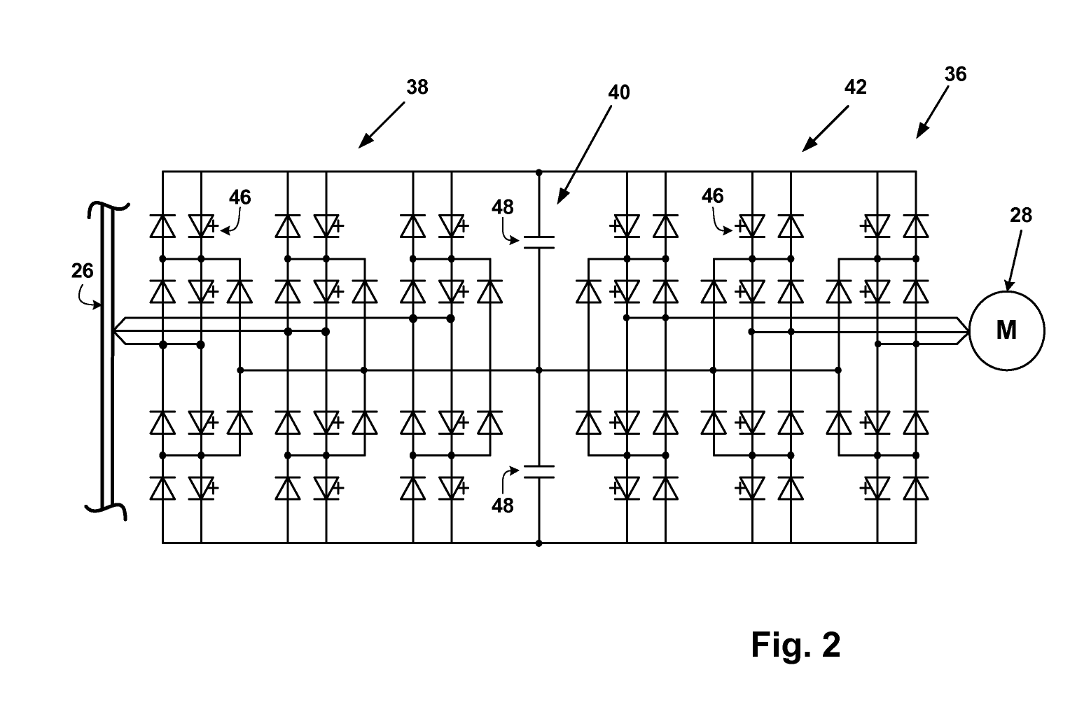

An example of an ASD 36 that may be used is shown in FIG. 2. The ASD 36 includes an ARU 38 connected by a DC link or bridge 40 to an inverter unit (INU) 42. The ARU 38 and INU 40 may have the same construction, such as is shown in FIG. 2. In this embodiment, the ASD 36 is a neutral-point clamped converter (NPC) having three levels. Each of the ARU 38 and the INU 40 comprise a plurality of controllable switching devices 46, which may be insulated gate bipolar transistors (IGBTs) or integrated gate commutated thyristors (IGCTs). The DC bridge 40 comprises a pair of capacitors 48 connected in series. It should be appreciated that other ASD topologies may be utilized for the ASDs 36. For example, ASDs having two levels or four or more levels may be used.

Each ASD 36 is a regenerative drive, capable of four quadrant operation, i.e., the ASD 36 can turn its associated motor 28 either forward or reverse, as well as decelerate in either direction The four combinations of forward and reverse rotation and forward and reverse torque are: (1.) forward rotation/forward torque (motoring); (2.) forward rotation/reverse torque (regeneration); (3.) reverse rotation/reverse torque (motoring); and (4.) reverse rotation/forward torque (regeneration). Combinations (2.) and (4.) are braking operations, wherein the motor 28 acts as a generator converting mechanical energy to electrical energy. The electrical energy generated by the motor 28 during braking is rectified by the INU 40, inverted by the ARU 38 and returned to the auxiliary bus 26 where it may be used by other motors 28 and other connected loads or stored for future use. Hence, the braking operation performed by the ASD 36 is called regenerative braking, which is more energy efficient than dynamic braking performed by conventional drives having fixed (pure diode) rectifiers. In dynamic braking, energy generated by a motor during braking is directed to a resistor bank where it is dissipated as heat.

Each ASD 36 is controlled using pulse width modulation (PWM), wherein the switching devices 46 are opened and closed to create a series of voltage pulses, wherein the average voltage is the peak voltage times the duty cycle, i.e., the “on” and “off” times of pulses. In this manner, a sine wave can be approximated using a series of variable-width positive and negative voltage pulses. The phase and the amplitude of the sine wave can be changed by changing the PWM pattern. Thus, each ASD 36 can be controlled to cause a phase shift between current and voltage, which permits the ASD 36 to be controlled to provide a power factor of one (unity). In addition, each ASD 36 can be controlled to compensate reactive power consumption in the main auxiliary bus 26a. More specifically, each ASD 36 can be controlled to inject capacitive reactive power or inductive reactive power. When an ASD 36 injects capacitive reactive power, the ASD 36 and its associated motor 28 have a leading power factor (a negative phase angle between current and voltage) and consume negative reactive power, i.e., the reactive power component is negative (in a phasor diagram). When an ASD 36 injects inductive reactive power, the ASD 36 and its associated motor 28 have a lagging power factor (a positive phase angle between current and voltage) and consume positive reactive power, i.e., the reactive power component is positive (in a phasor diagram).

Each ASD 36 is sized according to the rating of its associated motor 28 plus some spare capacity. The ARUs 38 may be sized with higher capacities than their associated INUs 40 if more reactive power compensation is anticipated. The ASDs 36, in aggregate, are sized with sufficient spare capacity to ameliorate disturbances in the generation plant 10 and the transmission network 18, such as power-loss ride-throughs and load rejections. A load rejection occurs when a significant load on the transmission network 18 is disconnected from the generation plant 10. In the event of such disturbances, the ARDs 36 are controlled by a dynamic voltage controller 66 to suppress transient over-voltages or under-voltages that may occur as a result thereof.

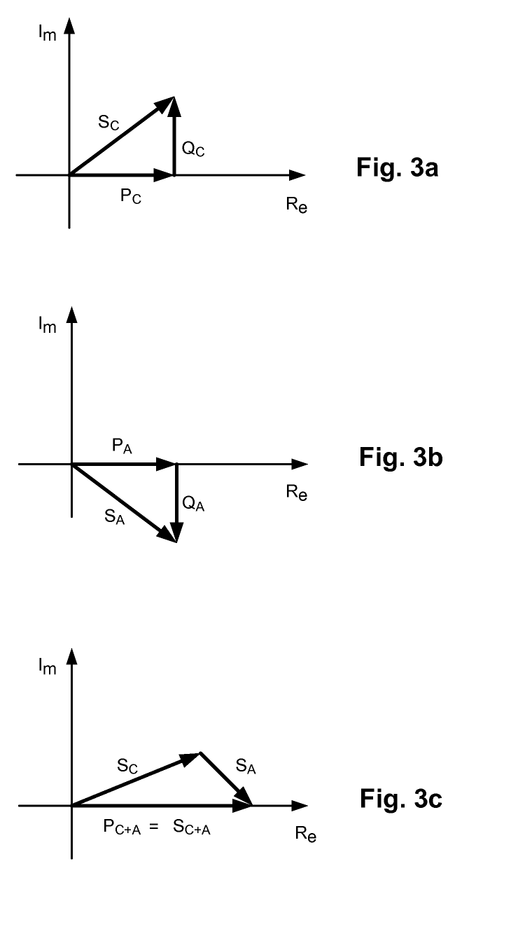

FIGS. 3a-c are phasor diagrams showing how the reactive power in the main auxiliary bus 26a can be controlled. In FIG. 3a, the phasor diagram shows the apparent power of the constant speed motors 29. P_{C} represents the active power consumed and Q_{C} represents the reactive power consumed, such as by the coils in the motors 29a-z. S_{C} represents the resulting apparent power. In FIG. 3b, the phasor diagram shows the apparent power of the motors 28 with the ASDs 36, which are being controlled, inter alia, to compensate for the reactive power consumed by the constant speed motors 29a-z. P_{A} represents the active power consumed, Q_{A} represents the reactive power consumed by ARUs 38 and S_{A} represents the resulting apparent power. It should be noted that Q_{A} has the same length as Q_{C}, but is opposite in direction. FIG. 3c shows the combined power consumption for the constant speed motors 29a-z and the motors 28a-z with the ASDs 36. Since Q_{A} and Q_{C} are identical but of opposite direction, when a vector addition is performed using S_{A} and S_{C}, the resulting vector S_{C+A} is equal to P_{C+A}. In other words, the reactive power Q_{A} eliminates the reactive power Q_{C}.

It is clear from FIGS. 3a-c that if another angle of the apparent power S_{A} of FIG. 2b is chosen, S_{C+A}, would not be purely real. In this manner, the combined reactive power Q_{C+A} can be controlled by changing the angle of S_{A}.

In addition to the ASDs 36a-z and the constant speed motors 29a-z, capacitor banks 44a-z are connected in shunt to the main auxiliary bus 26a. Each capacitor bank 44 is connected to the main auxiliary bus 26 by a controllable switch 46.

A plurality of sensors 50 are provided for measuring real and reactive power at various locations in the auxiliary power system 22. Some of the sensors 50 may be incorporated into protection devices for the generator 12, the main transformer 14 and the auxiliary transformer(s) 24. Each sensor 50 may comprise a voltmeter, an ammeter and a phase angle measurement unit.

The ASDs 36a-z, the controllable switch(es) 46a-z and the sensors 50 are connected to a control system 54 through a data bus 56. The control system 54 includes one or more controllers 60 operable to execute an auxiliary power control program 62 stored in memory 63 associated with the controller(s) 60. The control system 54 may be a distributed control system operable to control the entire plant 10, including boilers, turbines and generators, such as the generator 12. The control system 54 may have a human machine interface (HMI) 58 comprising viewing and input devices, such as monitors, keyboards etc.

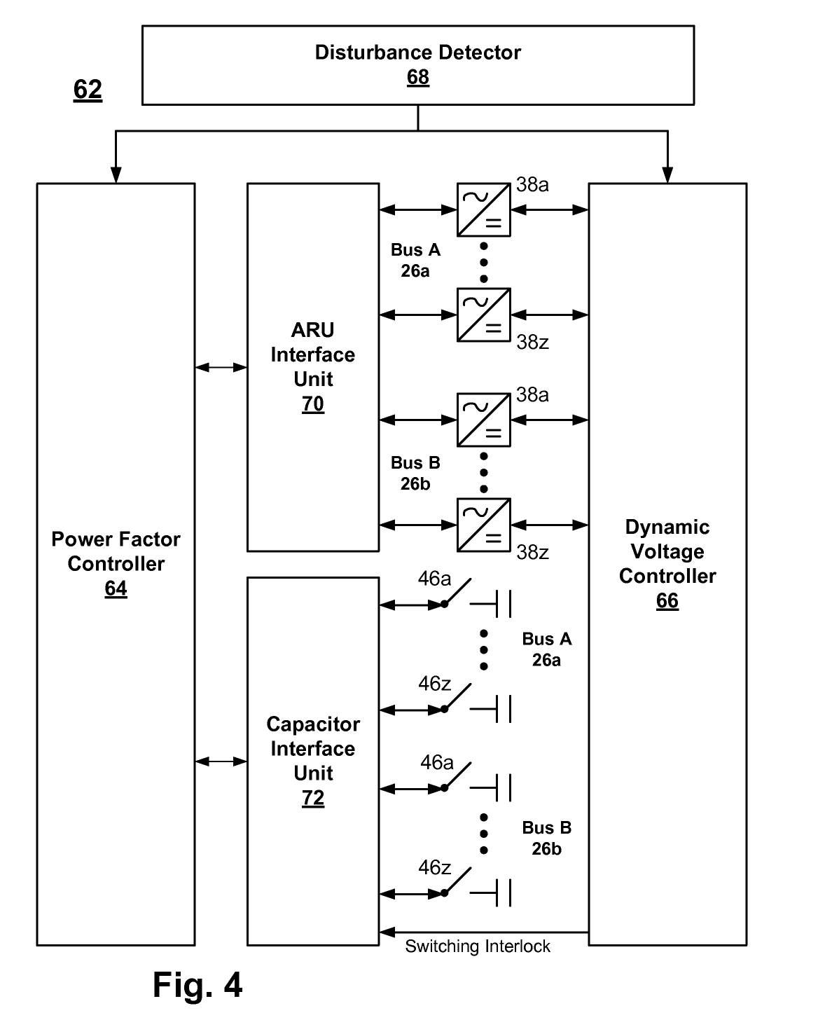

From the data bus 56, the auxiliary power control program 62 receives and monitors the following process variables: real power and reactive power of the auxiliary power system 22; the voltage magnitude of each auxiliary bus 26; the connected/disconnected status of the capacitor bank(s) 44; and the real and reactive power of the ARUs 38. Using the foregoing process variables, the auxiliary power control program 62 controls the power factor of the auxiliary power system 22, while providing steady-state voltage regulation and dynamic voltage support. As shown in FIG. 4, the auxiliary control program 62 generally comprises five blocks or modules: a power factor controller 64; a dynamic voltage controller 66; a disturbance detector 68; an ARU interface unit 70; and a capacitor interface unit 72.

The power factor controller 64 provides steady state power factor control. The power factor controller 64 calculates reactive power reference values (setpoints) for the ARUs 38 for the main auxiliary buses 26a,b and switching commands for the capacitor banks 44 for the main auxiliary buses 26a,b to keep the aggregate power factor of the auxiliary power system 22 at a desired value with balanced bus bar voltage profiles.

The dynamic voltage controller 66 is operable to provide dynamic voltage support of the auxiliary power system 22 during disturbances in order to prevent unexpected equipment tripping. When the dynamic voltage controller 66 is activated during a disturbance, the dynamic voltage controller 66 overrides the power factor controller 64 and blocks open/close signals to the switches 46 for the capacitor banks 44. In addition, closed-loop, line-side voltage regulators generate the reference values for the ARUs 38 instead of the power factor controller 64, There is a voltage regulator for each auxiliary bus 26a,b. Each voltage regulator is operable to implement a fast control algorithm and a slow control algorithm, depending on the severity of the disturbance. As the name implies, a fast control algorithm moves the voltage of an affected auxiliary bus 26a or 26b back to the setpoint voltage faster than a slow control algorithm. However, a fast control algorithm typically has more of an overshoot. An example of a fast control algorithm that may be used is a bang-bang control algorithm, wherein in the event of a voltage drop on an affected auxiliary bus, all of the ARUs 38 of the affected auxiliary bus are commanded to immediately inject as much reactive power as possible, and wherein in the event of a voltage spike on an affected auxiliary bus, all of the ARUs 38 of the affected auxiliary bus are commanded to immediately reduce reactive power as much as possible. In the event of a voltage drop, some of the ASDs 36 may even be commanded to perform regenerative braking to create real power for the affected auxiliary bus by extracting energy from the loads of the ASDs 36. Examples of slow control algorithms that may be used include a proportional (P) control algorithm, a proportional-integral (PI) control algorithm and a proportional-integral-derivative (PID) control algorithm. A PI control algorithm is typically used for the slow control algorithm. The main purpose of the voltage regulator (using either a fast or slow control algorithm) is to reduce the error between the setpoint (predefined voltage of the affected auxiliary bus) and the feedback value (actual voltage of the affected auxiliary bus) by changing the output (reactive power reference of ARUs 38) in a concerted manner. If the setpoint is higher than the feedback (voltage drop), the error will be positive. Assuming ARUs 38 are already in a mode of producing capacitive reactive power, the output of the voltage regulator will increase the reactive power reference of the ARUs 38 to inject more capacitive reactive power to the affected auxiliary bus so as to reduce or eliminate the voltage drop. On the other hand, if the setpoint is lower than the feedback (voltage spike), the error will be negative and the output of the voltage regulator will decrease the reactive power reference of ARUs 38 to inject less capacitive reactive power to the affected auxiliary bus as to reduce or eliminate the voltage overshoot. In such a voltage overshoot situation, the voltage regulator may also adjust the reactive power reference of the ARUs 38 such that inductive reactive power can be injected to the affected auxiliary bus.

The disturbance detector 68 is operable to automatically detect the appearance and disappearance of a voltage disturbance on the auxiliary buses 26a,b, based upon a set of predetermined criteria. For example, if the voltage of an auxiliary bus 26a or 26b is outside a predetermined range, a disturbance will be detected for that auxiliary bus. The predetermined range, may be 95% to 105% of the rated voltage value or setpoint, or 97% to 103% of the voltage setpoint, 98% to 102% of the voltage setpoint, or some other voltage range. Upon the detection of a voltage disturbance, the disturbance detector 68 activates the dynamic voltage controller 66, which overrides the operation of the power factor controller 64. When the voltage disturbance disappears, the disturbance detector 68 deactivates the dynamic voltage controller 66, thereby enabling the power factor controller 64 to once again control the ARU's 38 and the switches 46. As will be discussed further below, the disturbance detector 68 also determines a magnitude of a voltage disturbance on the auxiliary buses 26a,b. For example, if the voltage on an auxiliary bus 26a or 26b is at or greater than an upper magnitude (such as 106%, 107%, 108%, 109% or 110% of the setpoint voltage) or is at or less than a lower magnitude (such as 94%, 93%, 92%, 91% or 90% of the setpoint voltage), then the disturbance detector 68 determines that a voltage disturbance is severe.

The ARU interface unit 70 allocates the overall reactive power reference values calculated by the power factor controller 64 among the individual ARUs 38, which permits a flexible extension of the inventive method and apparatus to include the future installation of additional ARUs 38.

The capacitor interface unit 72 allocates the switching commands calculated by the power factor controller 64 among the capacitor banks 44, which permits a flexible extension of the inventive method and apparatus to include the future installation of additional capacitor banks 44.

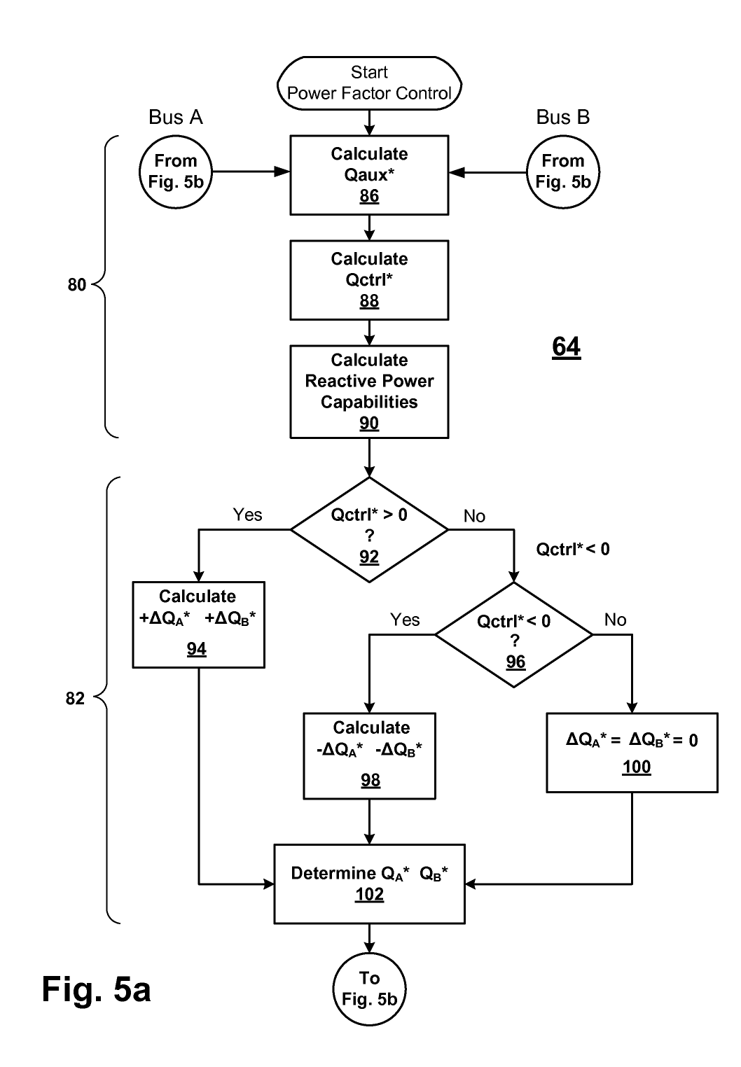

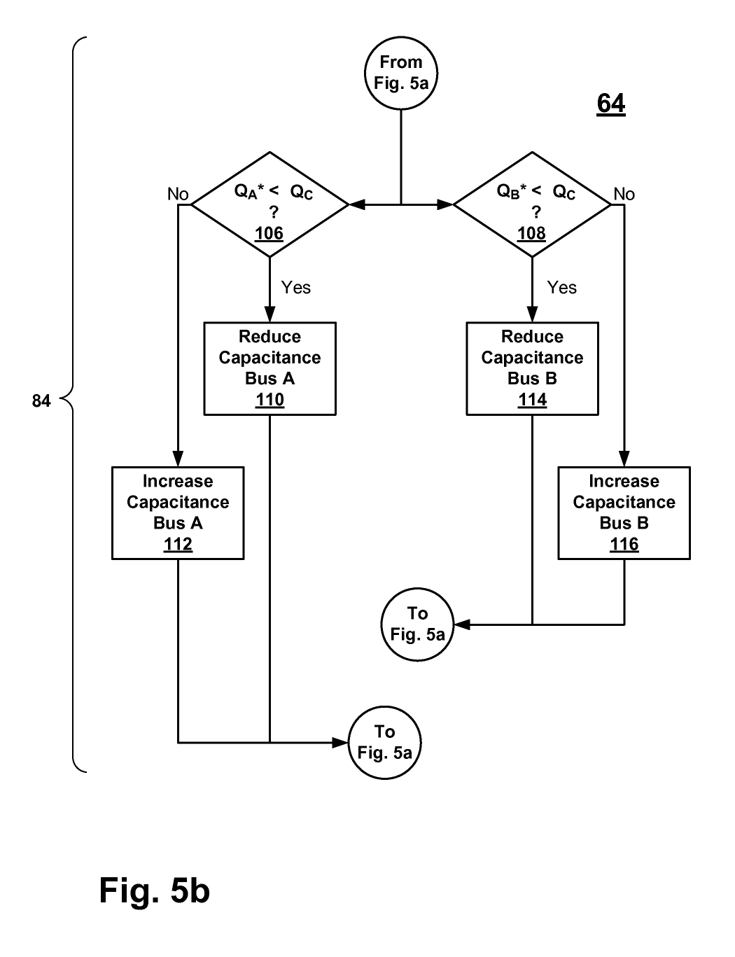

Referring now to FIG. 5, there is shown a flow chart of the power factor controller 64. In the flow chart and in the paragraphs below, the operation of the power factor controller 64 is described in terms of capacitive reactive power because power factor correction typically involves the injection of capacitive reactive power due to the inductive nature of the loads (motors 28). Thus, the variables relating to reactive power (e.g., Qaux*, Q* etc.) have positive values when capacitive reactive power is to be increased and negative values when capacitive reactive power is to be decreased.

Generally, the operation of the power factor controller 64 has three stages: an overall stage 80, a bus allocation stage 82 and an individual allocation stage 84. In the overall stage 80, a reactive power demand Qaux* for the entire auxiliary power system 22 is determined based on a desired power factor for the entire auxiliary power system 22. In the bus allocation stage 82, desired reactive power Q* is allocated to each of the main auxiliary buses 26a,b according to their voltage profile and available capacity. In the individual allocation stage 84, desired reactive power Q* is allocated between the ARUs 38 and the capacitor banks 44.

In step 86 of the overall stage 80, the reactive power demand Qaux* of the auxiliary power system 22 is calculated based on the difference between the current power factor of the auxiliary power system 22 (as measured by the sensor 50 connected to the input of the auxiliary transformer 24) and the reference (setpoint) power factor, which is stored in the memory 63. The reference power factor, however, may be changed manually by an operator through the HMI 68, or automatically by another software program. After step 86, the method proceeds to step 88, wherein the desired incremental reactive power output Qctrl* of all of the ARUs 38a-z and all of the capacitor banks 44a-z of the main auxiliary buses 26a,b is calculated. Qctrl* is the error between Qaux* (the reactive power reference of the auxiliary system) and Qaux (the feedback value of reactive power of auxiliary system). Therefore, Qctrl* actually indicates how much capacitive reactive power needs to be increased or decreased to meet the desired power factor. After step 88, the reactive power capabilities of all of the ARUs 38a-z and all of the capacitor banks 44a-z of the main auxiliary buses 26a,b are calculated in step 90, in order to determine the margin of controllable reactive power of each auxiliary bus bar 26a,b. This margin calculation provides information as to whether the desired incremental reactive power can be provided from the ARUs 38a-z and the capacitor banks 44a-z. For an ARU 38, this margin can be obtained by calculating the vector difference between the rated apparent power of the ARU 38 and the real power of the ARU 38, which is measured by a sensor 50 associated with the ARU 38.

In step 92 of the bus allocation stage 82, a determination is made whether the desired incremental reactive power output Qctrl* is greater than zero, i.e., whether increased capacitive reactive power is required. If the desired reactive power output Qctrl* is greater than zero, the required change (increase) in reactive power of the main auxiliary bus 26a (+ΔQ_{A}*) and the required change (increase) in reactive power of the main auxiliary bus 26b (+ΔQ_{B}*) are calculated in step 94, based on the upper voltage limits and reactive power capabilities of the main auxiliary buses 26a,b, respectively. If, however, the desired incremental reactive power output Qctrl* is not larger than zero, a determination is made in step 96 whether the required incremental reactive power Qctrl* is less than zero, i.e., whether increased inductive reactive power is required. If Qctrl*is less than zero, the required change (decrease) in capacitive reactive power of the main auxiliary bus 26a (−ΔQ_{A}*) and the required change (decrease) in capacitive reactive power of the main auxiliary bus 26b (−ΔQ_{B}*) are calculated in step 98, based on the lower voltage limits and reactive power capabilities of the main auxiliary buses 26a,b, respectively. If, in step 96, Qctrl* is determined not to be less than zero, it is determined in step 100 that both the required change in capacitive reactive power of the main auxiliary bus 26a (ΔQ_{A}*) and the required change in capacitive reactive power of the main auxiliary bus 26b (ΔQ_{B}*) are equal to zero. In step 102, the desired reactive power outputs Q_{A}*, Q_{B}* of the main auxiliary buses 26a,b, respectively, are determined. The desired reactive power output Q_{A}* is determined by summing the actual reactive power output of the auxiliary bus 26a (detected by the sensor 50a), and the incremental reactive power output of the auxiliary bus 26a which is determined based on the output of steps 94, 98, 100. Similarly, the desired reactive power output Q_{B}* is determined by summing the actual reactive power output of the auxiliary bus 26b (detected by the sensor 50b), and the incremental reactive power output of the auxiliary bus 26b which is determined based on the output of steps 94, 98, 100.

From step 102, the method proceeds to steps 106 and 108 of the individual allocation stage 84. In step 106, a determination is made whether Q_{A}* is less than all of the capacitive reactive power being provided from the capacitor banks 44 in the main auxiliary bus 26a. If the determination in step 106 is “yes”, the method proceeds to step 110, wherein an overall capacitance (reduction) requirement is generated, requiring the disconnection of some or all of the capacitor banks 44 that are currently connected to the main auxiliary bus 26a. In addition, an overall reference value is generated for the ARUs 38 to supply any capacitive reactive power that may be necessary to meet Q_{A}* after the capacitor bank(s) 44 has/have been disconnected. If the determination in step 106 is “no”, the method proceeds to step 112, wherein an overall capacitance (supplementation) requirement is generated requiring the connection of some or all of the capacitor banks 44 that are currently disconnected from the main auxiliary bus 26a. In addition, an overall reference value is generated for the ARUs 38 to supply any reactive power necessary to meet Q_{A}* after the capacitor bank(s) 44 has/have been connected to the main auxiliary bus 26a. In this regard, it is noted that, from an energy efficiency point of view, it is typically not desirable for the ARUs 38 to consume positive reactive power (i.e., inject inductive reactive power) to compensate for any excessive capacitive reactive power generated by the capacitor bank(s) 44. Thus, the ARUs 38 typically inject only required additional capacitive reactive power not supplied by the connected capacitor bank(s) 44. The steps 108, 114 and 116 are the same and are performed in the same manner as steps 106, 110, 112 described above, except they are performed for the main auxiliary bus 26b, and, thus, for purposes of brevity will not be described. The overall reference values for the ARUs 38 are transmitted to the ARU interface unit 70 for allocation to the individual ARUs 38, and the overall capacitance requirements are transmitted to the capacitor interface unit 72 for the generation of connect/disconnect signals to the switches 46.

From the foregoing description of the method of operation of the power factor controller 64, it should be appreciated that the switching of the capacitor banks 44 is used to make gross adjustments to the reactive power of the auxiliary power system 22, while control of the ARUs 38 is used to make finer adjustments to the reactive power of the auxiliary power system 22.

While the power factor controller 64 has been described with regard to the two auxiliary buses 26a,b, it should be appreciated that the power controller 64 can be utilized with only one auxiliary bus, or with three or more auxiliary buses to keep the aggregate power factor of an auxiliary power system at a desired value with balanced bus bar voltage profiles.

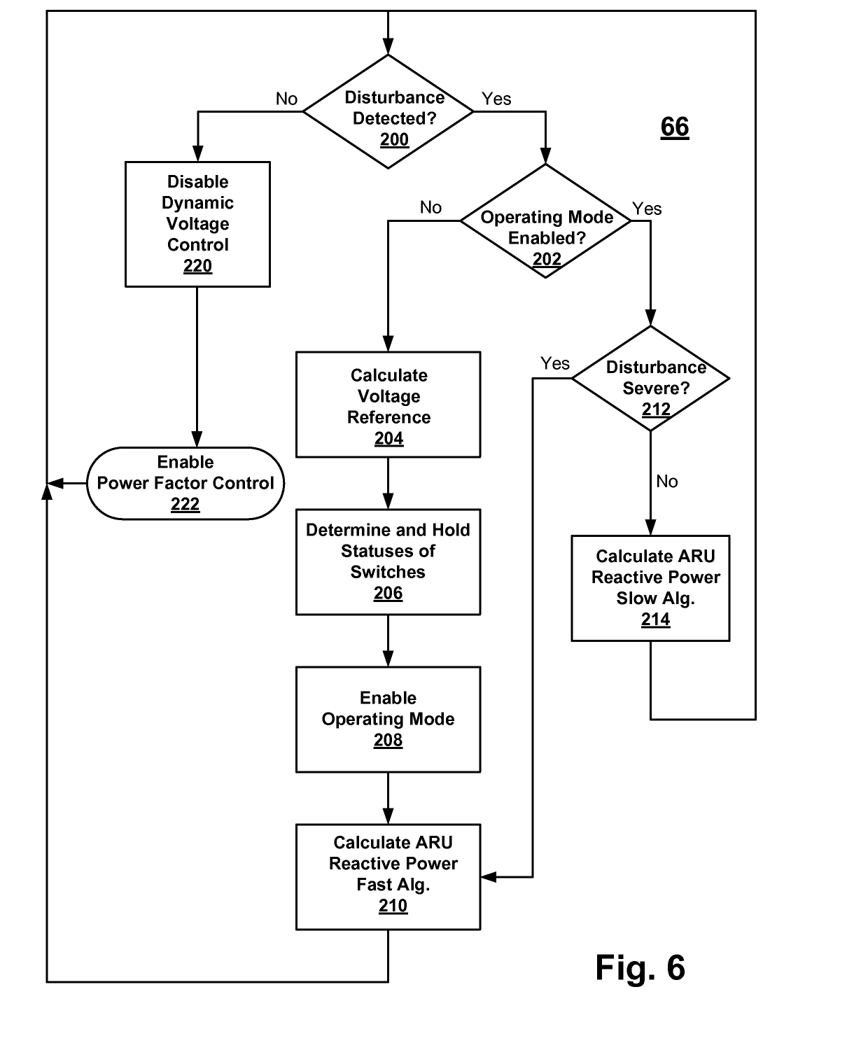

Turning now to FIG. 6, there is shown a flow chart of the dynamic voltage controller 66. In step 200, a determination is made whether a disturbance has occurred (e.g., the voltage of an auxiliary bus 26a or 26b is outside a range of 95% to 105% of the voltage setpoint). If a disturbance is detected, the method proceeds to step 202, wherein a determination is made whether the operating mode of the dynamic voltage controller 66 is enabled. If the operating mode is not enabled, the method proceeds to step 204, wherein a voltage reference for the voltage regulator of each affected auxiliary bus is calculated. After step 204, the method proceeds to step 206, wherein the statuses of the switches 46 are determined and the switches 46 are held in their current states (i.e., opened or closed, as the case may be). The method then proceeds to step 208, wherein the operating mode of the dynamic voltage controller 66 is enabled. After step 208, the method proceeds to step 210, wherein for each affected auxiliary bus, the reactive power references for the ARUs 38 are calculated by the voltage regulator using a fast control algorithm (e.g., a bang-bang control algorithm) and are transmitted directly to the ARUs 38. From step 210, the method proceeds back to step 200. The fast control algorithm ensures that the voltage regulator can respond to the voltage disturbance fast enough, so as to reduce the voltage drop or overshoot as much as possible to avoid undesirable equipment trips.

If, in step 202, a determination is made that the operating mode is enabled, then the method proceeds to step 212, wherein a determination is made whether the disturbance is severe (e.g., the voltage of an affected auxiliary bus is 90% or less of the voltage setpoint or 110% or more of the voltage setpoint). If the disturbance is severe, the method proceeds to step 210. If, however, the disturbance is not severe, for example the voltage of the affected auxiliary bus is lower than 110% of the voltage setpoint, but still higher than 105% (which is the voltage upper limit of steady-state operation), the method proceeds to step 214, wherein reactive power references for all of the ARUs 38 in the affected auxiliary bus are calculated by the voltage regulator using a slow control algorithm (e.g., a PI control algorithm) and are transmitted directly to the ARUs 38. From step 214, the method proceeds back to step 200.

If, in step 200, a disturbance is not detected, the method proceeds to step 220, wherein the operating mode of the dynamic voltage controller 66 is disabled. After step 220, the operating mode of the power factor controller 64 is enabled in step 222. From step 222, the method proceeds back to step 200.

From the foregoing description, it should be appreciated that the auxiliary power control program 62 provides a number of benefits. The coordinated control of the ARUs 38 and the capacitor banks 44 by the power factor controller 64 permits the overall power factor of the auxiliary power system 22 to be maintained at a reference value (such as in a range from 0.95 to 0.99) that provides for efficient energy use. Reducing the reactive power consumption of the plant auxiliary system 22 enables the generator 12 to provide more real power to the transmission network 18 while still maintaining the required reactive power capability. The reference value of the overall power factor of the auxiliary system 22 may be changed manually by an operator through the HMI 58, or automatically by the auxiliary power control program 62. For example, the auxiliary power control program 62 may automatically (or upon receipt of a command) change the reference value of the overall power factor of the auxiliary power system 22 so that during peak load hours (such as from 8:00 AM to 12:00 Midnight) the overall reactive power of the auxiliary power system 22 improves the leading phase operation (negative power factor) of the generator 12 and during off-peak load hours (such as from 12:00 Midnight to 8:00 AM) the overall reactive power of the auxiliary power system 22 improves the lagging phase operation (positive power factor) of the generator 12.

In the event there is a voltage spike or sag on the main auxiliary buses 26a,b, the operation of the power factor controller 64 is deactivated and the dynamic voltage controller 66 takes over control of the ARUs 38 to quickly increase or decrease the reactive power of the auxiliary power system 22. For example, if there is voltage sag and the ARUs 38 are providing capacitive reactive power, the ARUs 38 are controlled to increase capacitive reactive power, whereas if there is a voltage spike, the ARUs 38 are controlled to decrease capacitive reactive power or even inject inductive reactive power. In this manner, the dynamic voltage controller 66 helps to prevent loads, such as the motors 28, 29 from tripping off line as a result of a voltage spike or sag. Once the voltage spike or sag disappears, the operation of the power factor controller 64 is again activated.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. Computer readable medium having computer-readable instructions stored thereon for execution by a processor to perform a method of controlling power in an auxiliary power system of a thermal power plant having a generator and one or more auxiliary buses, each auxiliary bus having one or more adjustable speed drives connected thereto and one or more capacitance sources connected thereto, each adjustable speed drive having an active rectifier unit, the method comprising:
monitoring a voltage of each auxiliary bus;
controlling the power factor of the auxiliary power system to have a predetermined power factor value, the controlling of the power factor comprising controlling the reactive power of each adjustable speed drive and each capacitance source; and
when an auxiliary bus is affected by a voltage disturbance such that its voltage is outside a predetermined range, stopping the control of the power factor of the auxiliary power system and controlling the voltage on the affected auxiliary bus to move the voltage back into the predetermined range, the controlling of the voltage comprising:
increasing the reactive power of the one or more adjustable speed drives connected to the affected auxiliary bus when the voltage of the affected auxiliary bus is below the predetermined range; and
decreasing the reactive power of the one or more adjustable speed drives connected to the affected auxiliary bus when the voltage of the affected auxiliary bus is above the predetermined range.

2. The computer readable medium of claim 1, wherein the predetermined range is based on percentages of a setpoint voltage.

3. The computer readable medium of claim 2, wherein the step of controlling the voltage on the affected auxiliary bus further comprises:
determining a magnitude of the voltage disturbance;
if the magnitude is at or greater than an upper value, using a first control algorithm to increase or decrease the reactive power; and
if the magnitude is less than the upper value, using a second control algorithm to increase or decrease the reactive power.

4. The computer readable medium of claim 3, wherein the first control algorithm is operable to move the voltage of the affected auxiliary bus back to the setpoint faster than the second control algorithm.

5. The computer readable medium of claim 4, wherein the first control algorithm is a bang-bang control algorithm and the second control algorithm is a proportional-integral control algorithm.

6. The computer readable medium of claim 4, wherein the predetermined range is 90% to 110% of the setpoint voltage.

7. The computer readable medium of claim 6, wherein the upper value is plus or minus 10% of the setpoint voltage.

8. The computer readable medium of claim 4, wherein upon an initial detection of the voltage disturbance, the first control algorithm is used to increase or decrease the reactive power, and wherein after a period of time after the initial detection, the step of determining the magnitude of the voltage disturbance is performed.

9. The computer readable medium of claim 1, wherein the step of controlling the voltage on the affected auxiliary bus further comprises performing regenerative braking of the one or more adjustable speed drives when the voltage disturbance is a voltage drop.

10. The computer readable medium of claim 1, wherein the method of controlling the voltage on the affected auxiliary bus comprises injecting inductive reactive power onto the affected auxiliary bus.

11. The computer readable medium of claim 1, wherein after the voltage disturbance disappears, again controlling the power factor of the auxiliary power system to have a predetermined power factor value.

12. The computer readable medium of claim 1, wherein the controlling of the power factor is performed to improve leading phase operation of the generator during heavy load conditions and is performed to improve lagging phase operation of the generator during light load conditions.

13. The computer readable medium of claim 1, wherein in each auxiliary bus, each capacitance source comprises a controllable switch connecting a capacitor bank in shunt to the auxiliary bus, and wherein controlling the reactive power of each capacitance source comprises opening or closing the controllable switch of the capacitance source.

14. The computer readable medium of claim 13, wherein the controlling of the power factor of the auxiliary power system comprises:
determining a desired capacitive reactive power for each auxiliary bus;
for each auxiliary bus, determining whether the desired capacitive reactive power is less than the capacitive reactive power provided by the one or more capacitance sources of the auxiliary bus;
for each auxiliary bus, if the desired capacitive reactive power is less than the capacitive reactive power provided by the one or more capacitance sources, then:
opening one or more of the controllable switches to disconnect one or more of the capacitor banks from the auxiliary bus; and
controlling the one or more adjustable speed drives to provide any capacitive reactive power necessary to provide the auxiliary bus with the desired capacitive reactive power with the one or more controllable switches having been opened; and
for each auxiliary bus, if the desired capacitive reactive power is greater than the capacitive reactive power provided by the one or capacitance sources, then:
closing one or more of the controllable switches to connect one or more of the capacitor banks to the auxiliary bus; and
controlling the one or more adjustable speed drives to provide any capacitive reactive power necessary to provide the auxiliary bus with the desired capacitive reactive power with the one or more controllable switches having been closed.

15. Apparatus for controlling power in an auxiliary power system of a thermal power plant having a generator and one or more auxiliary buses, the apparatus comprising:
one or more adjustable speed drives for connection to the one or more auxiliary buses, each adjustable speed drive having an active rectifier unit;
one or more capacitance sources for connection to the one or more auxiliary buses;
sensors for measuring voltage and reactive power on the one or more auxiliary buses;
a controller operable to perform a method of controlling power in the auxiliary power system, the method comprising:
monitoring a voltage of each auxiliary bus;
controlling the power factor of the auxiliary power system to have a predetermined power factor value, the controlling of the power factor comprising controlling the reactive power of each adjustable speed drive and each capacitance source; and
when an auxiliary bus is affected by a voltage disturbance such that its voltage is outside a predetermined range, stopping the control of the power factor of the auxiliary power system and controlling the voltage on the affected auxiliary bus to move the voltage back into the predetermined range, the controlling of the voltage comprising:
increasing the reactive power of the one or more adjustable speed drives connected to the affected auxiliary bus when the voltage of the affected auxiliary bus is below the predetermined range; and
decreasing the reactive power of the one or more adjustable speed drives connected to the affected auxiliary bus when the voltage of the affected auxiliary bus is above the predetermined range.

16. The apparatus of claim 15, wherein the one or more adjustable speed drives comprises a plurality of adjustable speed drives, each adjustable speed drive being a multi-level neutral-point converter.

17. The apparatus of claim 15, wherein each capacitance source comprises a controllable switch connecting a capacitor bank in shunt to the auxiliary bus, and wherein controlling the reactive power of each capacitance source comprises opening or closing the controllable switch of the capacitance source.

18. The computer readable medium of claim 17, wherein the controlling of the power factor of the auxiliary power system comprises:
determining a desired capacitive reactive power for each auxiliary bus;
for each auxiliary bus, determining whether the desired capacitive reactive power is less than the capacitive reactive power provided by the one or more capacitance sources of the auxiliary bus;
for each auxiliary bus, if the desired capacitive reactive power is less than the capacitive reactive power provided by the one or more capacitance sources, then:
opening one or more of the controllable switches to disconnect one or more of the capacitor banks from the auxiliary bus; and
controlling the one or more adjustable speed drives to provide any capacitive reactive power necessary to provide the auxiliary bus with the desired capacitive reactive power with the one or more controllable switches having been opened; and
for each auxiliary bus, if the desired capacitive reactive power is greater than the capacitive reactive power provided by the one or capacitance sources, then:
closing one or more of the controllable switches to connect one or more of the capacitor banks to the auxiliary bus; and
controlling the one or more adjustable speed drives to provide any capacitive reactive power necessary to provide the auxiliary bus with the desired capacitive reactive power with the one or more controllable switches having been closed.

19. The apparatus of claim 15, wherein the predetermined range is based on percentages of a setpoint voltage, and wherein the step of controlling the voltage on the affected auxiliary bus further comprises:
determining a magnitude of the voltage disturbance;
if the magnitude is at or greater than an upper value, using a first control algorithm to increase or decrease the reactive power; and
if the magnitude is less than the upper value, using a second control algorithm to increase or decrease the reactive power.

20. The apparatus of claim 19, wherein the first control algorithm is operable to move the voltage of the affected auxiliary bus back to the setpoint faster than the second control algorithm.
